(19) United States
(12) Patent Application Publication
(10) Pub. No.: US 2012/0205914 A1
(43) Pub. Date: Aug. 16, 2012

(54) WIND ENERGY CONVERTER

(76) Inventor: Marcus Reich, Vacaville, CA (US)

(21) Appl. No.: 13/499,291

(22) PCT Filed: Sep. 29, 2010
(86) PCT No.: PCT/CN10/77476

§ 371 Date: Apr. 29, 2012

(30) Foreign Application Priority Data
Sep. 30, 2009 (CN) 200920219585.0

(51) Int. Cl. F03D 9/00

(52) U.S. Cl. 290/55

(57) ABSTRACT

A wind energy converter comprises an automatic regulating and lightning-strike absorbing component that consists of a stainless steel S-shaped arm, a stainless steel cable (1), a counter weight (3) connected to the stainless steel cable (1), and a separate stainless steel cable (9). The stainless steel S-shaped arm is mounted on a fulcrum and connected to a rotor head, wherein the rotor head supports rotor blades which rotate a generator unit in the rotor head to generate electric power. The stainless steel cable (1) is suspended from the stainless steel S-shaped arm, and freely pivots in relation to wind speed. The separate stainless steel cable (9) extends from the top of the turbine tower through the middle of the counter weight (3) to the bottom of the turbine tower. The wind energy converter directly guides the electrical charges from lightning stroke or turbine friction to the ground, thus preventing people and livestock from being injured and avoiding damage to the turbine.

### FIELD OF THE INVENTION

The present invention relates to a wind turbine, more particularly to a wind energy converter for converting wind energy into another form of energy (such as electrical energy).

### BACKGROUND OF THE INVENTION

At present, a wind generator/turbine consists of two main parts wherein one is a windmill (set of blades) that serve to convert wind energy into mechanical energy, and the other is a generator serving to convert mechanical energy into electrical energy.

However, the existing wind turbine is not efficient and the blades are subject to wind power magnitudes that may cause over-speed or under-speed conditions, which make the turbine incapable of maintaining revolutions per minute (RPM). Moreover, reverse (opposite) wind forces between the blades make the noise level relatively great.

### SUMMARY OF THE INVENTION

The design of the present invention will overcome the disadvantages of the existing art (invention). The present invention provides a wind energy converter consisting of a regulator and a lighting strike absorber that will (a) increase the efficiency of the wind energy converter; (b) prevent damage from overheating or high voltage conditions (c) protect the rotor blades from excessive wind forces; and significantly reduce noise.

According to an aspect of the present invention, the wind energy converter comprises: a stainless steel S-shaped arm mounted to a fulcrum, which is connected to a rotor head wherein the rotor head is used to support rotor blades, by which a generator unit within the rotor head is rotated to generate electrical power; a stainless steel cable suspended from the stainless steel S-shaped arm that pivots freely in relation to wind speed; a counter weight attached to the stainless steel cable; and a separate stainless steel cable that extends from the top of the turbine tower, passes through the middle of the counter weight, and extends to the bottom of the turbine tower.

According to another aspect of the present invention, a stainless steel S-shaped arm is provided with a fulcrum fitting welded thereon, and that fulcrum fitting is used as an attach point to the turbine tower. Further, the stainless steel S-shaped arm is provided with a fitting welded thereon and that fitting is used to attach the rotor head and rotor blades. Furthermore, the stainless steel S-shaped arm is provided with a fitting welded thereon and that fitting is used to attach the stainless steel cable.

According to a further aspect of the present invention, it provides a cylindrical counter weight, which opposes the movement of the stainless steel S-shaped arm and the rotor head in relationship to wind speed, protecting the rotor head from over speed conditions.

According to a further aspect of the present invention, it provides a separate stainless steel cable that extends from the top of the turbine tower to the bottom of the same and is connected to a grounding rod or other means actively grounding, transmitting any charges caused by lightning strike or friction (static electricity) to a grounding point.

The present invention provides an effective and simple method to adjust the turbine rotors and protect the turbine and the turbine tower from the wind power and lightning strikes and at the same time allows the rotors and turbine to operate continuously to produce electricity. This is especially useful in under-developed countries and in rural areas where there is no access to an electrical power grid. The present invention relates to an automatic regulator and lightning strike absorber on the wind turbine tower. More particularly, the present invention relates to stainless steel S-shaped arm, a stainless steel cable, a counter weight, and a stainless steel cable, the combination of which allows attachment of the rotor head to a fixed rotor blade. The rotor head rotates the generator to produce electricity, allowing operation of the generator regardless of wind speed. The automatic regulator, according to the present invention allows the rotor head to rotate regardless of wind speed, such that it prevents damage to the rotor and turbine tower during strong wind conditions. The counter weight connected to the stainless steel S-shaped arm opposes the wind power; therefore, permitting the rotor head to remain in an appropriate position whereby the rotor head continuously rotates. The stainless steel cable, the counter weight, and the separate stainless steel cable discharge the lightning strike electrical charges and/or static electrical charges directly to the ground, protecting the generator and electrical storage components (batteries).

It should be appreciated that the above general description, and the following detailed description, are provided in illustration form for further describing the present invention claimed herein.

### BRIEF DESCRIPTION OF THE DRAWINGS

Figures, constituting a part of the Specification, are used for contributing to a further understanding of the present invention. These figures illustrate embodiments of the present invention and are used to explain the principle of the present invention along with the Specification.

FIG. 1 shows the wind energy converter according to the embodiment of the present invention;

FIG. 2 shows the lightning strike absorber according to the embodiment of the present invention; and

FIG. 3 is a partial enlargement view of the lightning strike absorber shown in FIG. 2.

### DETAILED DESCRIPTION

Hereinafter, the embodiment of the present invention is described in detail in conjunction with Figures. However, the present invention can be embodied in various ways, covered by the scope of the affixed Claims. In Figures, the same reference number represents the same component.

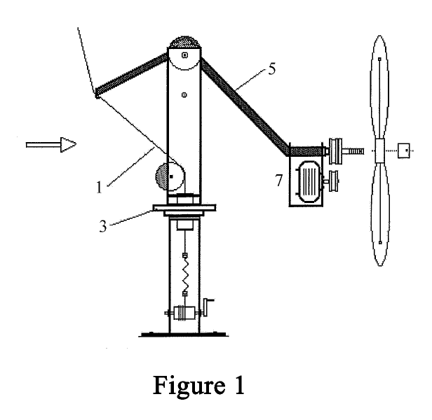

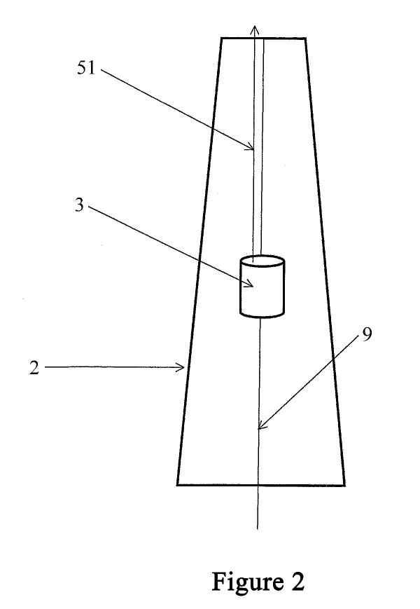

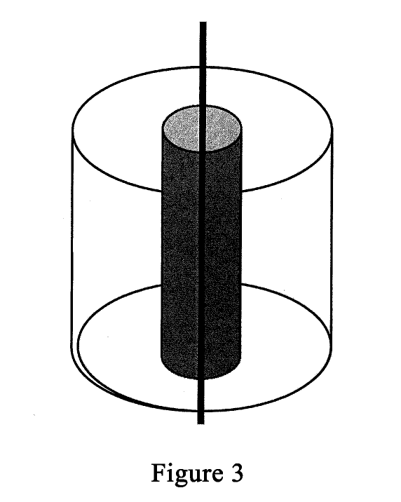

FIG. 1 shows the wind energy converter according to the embodiment of the present invention; FIG. 2 shows the lightning strike absorber according to the embodiment of the present invention; and FIG. 3 is an enlarged view of the lightning strike absorber, shown in FIG. 2. As shown in Figures, the turbine blade is mounted to the rotor head and the regulator arm and the regulator 5 is connected to the extended portion of the tower. A suspended cable 1 is attached to the end of the regulator 5 and further attached to the counter weight 3. A separate stainless steel cable 9 extends from the top of the turbine tower to the bottom of the same with reference number 2 indicating the turbine tower base.

The wind energy converter comprises: a stainless steel S-shaped arm mounted on a fulcrum and connected to a rotor head, wherein the rotor head is used to support the rotor blade, which rotates the generator unit in the rotor head to produce electricity; a stainless steel cable 1 suspended from the stainless steel S-shaped arm that pivots freely in relation to wind speed; a counter weight 3 which is connected via the stainless steel cable; and a separate stainless steel cable 9 that extends from the top of the turbine tower through the middle of the counter weight to the bottom of the turbine tower, wherein the rotor head is attached to a pivot beam utilizing a welded fulcrum point fixed to a stationary clevis that is connected to the turbine tower. The turbine tower incorporates a freely rotating tower head, which permits the free movement of the stainless steel S-shaped arm and the up and down movement of the regulating components.

Besides using the components that are attached by welding, the stainless steel S-shaped arm, according to the present invention, is formed utilizing a stainless steel rod with uniform thickness (diameter). The stainless steel S-shaped arm is provided with a fulcrum fitting welded thereon, which serves as an attachment point to the turbine tower, utilizing a ceramic washer as an isolator.

The S-shaped arm is also provided with a fitting welded thereon which serves to attach the rotor head and rotor blades (non-specific),wherein the rotor blade is formed by a machined or stamped piece of steel with a sealed bearing.

The S-shaped arm is also provided with a fitting welded thereon which is opposite to the rotor head attach point that is used for attachment of the steel cable.

The stainless steel cable 1 extends downward and passes through the center of the turbine tower's rotating head, passes over the pulley permanently fixed to the turbine tower, and finally is attached to the counter weight. The length of stainless steel cable varies depending on the height of the tower. However, the stainless steel cable's diameter and strength over the entire length are constant.

The stainless steel cable 1 is provided with an eyelet installed on the upper end, to use a stainless bolt, washer, and nut for security to affix the stainless steel cable to the stainless steel -shaped arm.

Moreover, the stainless steel cable 1 has a clevis attach point at the lower end and that clevis attach point is affixed to the counter weight 3 by using stainless bolt, washer and nut.

The counter weight, according to the present invention, is used to prevent the movement of the stainless steel S-shaped arm and the rotor head, and is connected by the stainless steel cable 1 wherein the counter weight is freely suspended from the cable. The counter weight 3 has a cylindrical shape with a hole perpendicularly drilled through the counter weight 3. The counter weight 3 is provided with a clevis fitting affixed to the top portion and is used to connect to the stainless steel cable 1. In addition, the counter weight 3 freely travels up and down along the separate stainless steel cable affixed to the turbine tower. The counter weight 3 serves to provide opposing force with respect to the rotor blade. When the wind speed is changed, the counter weight 3 (along with the turbine blade) will move (pivot) up and down.

As shown in FIGS. 2 and 3, the lightning strike absorber, according to the present invention, is illustrated wherein the separate stainless steel cable 9 is used for transmitting any electrical charges from a lightning strike or static friction to a grounding point, and that the separate stainless steel cable, extending from the top of the turbine tower to the bottom of the same, is affixed to both ends of the turbine tower by using the eyelet and the stainless steel bolt, washer and nut, and the separate stainless steel cable is connected to the grounding rod or other active grounding means at the lower attach point of the turbine tower.

As shown in FIG. 3, the counter weight 3 has tubular shape with brass electrical brushes installed along the inside diameter of the drilled hole (as shown in FIG. 3, the brushes are covered by the shaded area). The brass brushes directly contact the separate steel grounding cable that is affixed to the turbine tower. The brushes transmit the electrical current from the counter weight 3 to the separate cable 9 and further to the ground. When moving along the separate stainless steel cable, the counter weight 3 transmits the electrical current from the counter weight 3 to the separate stainless steel cable, and then to the ground. As a result, the wind energy converter is protected from the potential of lightning strikes or other electrical surges.

In addition, the present invention is further provided with at least two sets of rotor blades, which rotate in opposite directions, and the blades and the regulator 5 are made of stainless steel. The blades rotating in opposite directions convert at least 60% of the wind energy into electrical energy and increase efficiency by 35%, compared to conventional wind turbines with one rotor head, and wherein the noise produced by the opposite rotation between the blades is reduced. The wind energy converter can effectively produce energy in cases when the wind speed is only 3 meters per second (6.5 miles per hour).

The wind energy converter, according to the present invention, consists of an automatic regulator (or regulating system) and a lightning strike absorber wherein the automatic regulator comprises a regulator, a stainless steel cable and a counter weight. Moreover, the automatic regulator and the lightning strike absorber utilize the stainless steel cable suspended from the steel S-shaped arm mechanism mounted on the fulcrum, and the stainless steel cable freely pivots in relation to the wind speed and prevents any type of damage to the rotor blades. The regulator permits the rotor blades to rotate regardless of the wind speed, which permits that energy to be generated from the rotor driven generator. The up and down movement of the rotor head is controlled by the attached counter weight at the lower portion of the turbine tower. The counter weight slides up and down on the steel cable affixed to the tower's lower portion and the stainless steel cable is connected to a grounding stake. The combination of the stainless steel S-shaped arm, the stainless steel cable, the counter weight, and the steel cable direct electrical charges from a lightning strike or turbine friction (static electricity) directly to the ground, preventing injury to humans and livestock and prevents damage to the wind energy converter.

The regulator and the lightning strike absorber, according to the present invention, together with each other, permit the unrestricted operation of the wind energy converter turbine and protect the wind energy converter from strong winds and the electrical charges caused by lightning strikes or static electricity.

Furthermore, the regulator and the lightning strike absorber components are made from stainless steel material, which are corrosion-resistant. Maintenance of the invention is reduced, maintenance costs are reduced, and the wind energy converter will have longer reliability and dependability. In addition, the present invention does not require any sensors or auto shutdown electronics, and the number of the moving parts is smaller, reducing the cost.

Although the present invention has been described referring to the Figures and preferable embodiment, it should be obvious to those skilled in the art that, within the spirit and scope of the present invention, various modifications and variations can be made to the present invention, all of which should be covered in the affixed Claims and its equivalent.

What is claimed is:

1. A wind energy converter characterized and comprising an automatic regulating system and lightning-strike absorber component that consists of:
a stainless steel S-shaped arm, mounted on a fulcrum and connected to a rotor head wherein the rotor head supports rotor blades which rotate a generator unit in the rotor head to generate electrical power;
a stainless steel cable, suspended from the stainless steel S-shaped arm and that freely pivots in relation to wind speed;
a counter weight, connected to the stainless steel cable; and
a separate stainless steel cable, extending from the top of turbine tower through the middle of the counter weight to the bottom of the turbine tower.

2. The wind energy converter, according to claim 1, characterized in that the rotor head is attached to a pivot beam utilizing a welded fulcrum point affixed to a stationary clevis that is connected to the turbine tower, the turbine tower incorporates a freely rotating tower head which permits the free movement of the stainless steel S-shaped arm and the up and down movement of the automatic regulator and lightning-strike absorber component.

3. The wind energy converter, according to claim 1, characterized in that stainless steel rod forms the stainless steel S-shaped arm with uniform thickness.

4. The wind energy converter, according to claim 1, characterized in that the stainless steel S-shaped arm is provided with a fulcrum fitting welded thereon, which serves as an attach point to the turbine tower with a ceramic washer as isolator.

5. The wind energy converter, according to claim 1, characterized in that the stainless steel S-shaped arm is provided with a fitting welded thereon, which serves to attach the rotor head and rotor blades wherein the rotor blade is formed by a machined (stamped) piece of stainless steel with a sealed bearing.

6. The wind energy converter, according to claim 1, characterized in that the stainless steel S-shaped arm is provided with a fitting welded thereon, which is opposite to the rotor head attach point that is used for attach the stainless steel cable.

7. The wind energy converter, according to claim 1, characterized in that the stainless steel cable extends downward and passes through the center of the turbine tower rotating head, passes over a pulley permanently fixed to the turbine tower, and the length of stainless steel cable varies depending on the height of the turbine tower.

8. The wind energy converter, according to claim 1, characterized in that the stainless steel cable is provided with an eyelet installed on the upper end, to use a stainless steel bolt, washer, and nut to affix the stainless steel cable to the stainless steel S-shaped arm.

9. The wind energy converter, according to claim 1, characterized in that the stainless steel cable has a clevis attach point at the lower end and the clevis attach point is affixed to the counter weight by using a stainless steel bolt, washer and nut.

10. The wind energy converter, according to claim 9, characterized in that the counter weight is used to prevent the movement of the stainless steel S-shaped arm and the rotor head wherein the counter weight is freely suspended from the stainless steel cable.

11. The wind energy converter, according to claim 9, characterized in that the counter weight has a cylindrical shape with a hole perpendicularly drilled through the counter weight and the counter weight is provided with a clevis fitting affixed to the top portion and used for attaching the stainless steel cable.

12. The wind energy converter, according to claim 11, characterized in that the counter weight has brass electrical brushes installed along the inside diameter of the drilled hole and the brass brushes directly contact the separate stainless steel cable which is affixed to the turbine tower.

13. The wind energy converter, according to claim 11, characterized in that the counter weight freely travels up and down along the separate stainless steel cable affixed to the turbine tower.

14. The wind energy converter, according to claim 1, characterized in that the separate stainless steel cable is affixed to both ends of the turbine tower by using an eyelet and a stainless steel bolt, washer and nut.

15. The wind energy converter, according to claim 1, characterized in that the separate stainless steel cable is connected to a grounding rod or other active grounding means at the lower attach point of the turbine tower.

16. The wind energy converter, according to claim 1, characterized in that the separate steel cable transmits any electrical charges caused by lightning strike or static friction directly to a grounding point.
